(19) United States
(12) Patent Application Publication
(10) Pub. No.: US 2014/0331559 A1
(43) Pub. Date: Nov. 13, 2014

(54) MECHANICAL ELEVATING AND REVOLVING GATES

(71) Applicant: Olga Morozov, (US)

(72) Inventor: Valeriy Vladimirovich Morozov, Moscow (RU)

(21) Appl. No.: 13/984,541

(22) PCT Filed: Oct. 28, 2011
(86) PCT No.: PCT/RU11/00833

§ 371 Date: Jun. 19, 2014

(30) Foreign Application Priority Data
Jun. 8, 2011 (RU) 2011122985

(51) Int. Cl. E06B 3/50; E05F 1/00

(52) U.S. Cl. CPC E06B 3/50; E05F 1/00
USPC 49/208

(57) ABSTRACT

The mechanical elevating and revolving gates consist of a support box, an overlapping monolithic plate, lever mechanisms, and hinges. The overlapping plate is raised vertically upwards by a predetermined amount (up to 1 meter), after which the said plate is turned by 90 degrees, completely opening an aperture in the support box and forming a protective cover above the gates. These two movements are carried out by a single mechanism which transforms from a crank mechanism into a four-link chain mechanism and vice versa. Such transformation is possible due to two original hinges attaching the upper part of the overlapping plate to the support box. Such gates do not require locks and bolts. Even heavy snow accumulations will not prevent the gates from opening and closing.

The invention is directed to the construction and can be used for construction of entrance and garage doors.

Various types of mechanical gates are used to enter an estate or a garage. These gates can be divided into four groups: hinged, rolling, horizontally sliding ones, and elevating and revolving gates with a monolithic plate. The last group is the closest to the claimed invention. In the prior art solutions, the monolithic plate slightly turns around its horizontal axis, then passes through the support box inside the premise and takes up a position under the garage ceiling (see, for example, U.S. Pat. No. 5,337,520, cl. E 05 F 15/00, 1994).

The disadvantages of the prior art solution are as follows:
1. Need for a ceiling and the impossibility of using such gates to enter an estate;
2. Side clearances between the plate and the box;
3. Need for using additional bolts and locks to fix the gates in a closed position;
4. A plate positioned under the ceiling obturates light fixtures and requires an increase in the garage height, which makes its heating more expensive;
5. Impossibility of opening the gates in winter if snow is piled against them (the turn around the horizontal axis becomes impossible).

Patent RU 2112852 cl. E 05 F 15/16 1997 has been selected as the prototype of the invention. This patent describes gates with a monolithic plate that moves from the vertical position to the horizontal position, thus forming a protective cover above the garage entrance. This solution has the above disadvantages (apart from item 2).

The object of the invention is to improve the performance of gates. The stated object is achieved by means of solution, according to which two lateral sides of the plate are connected, in the middle part of the plate, by hinges with two rods of the drive, and two slide blocks having the shape of a circle with parallel cut-off segments are rigidly fixed on the upper parts of these sides, and two guide members with grooves in each of them accommodating slide blocks of the monolithic plate are secured on the side walls in the upper part of the box, wherein the upper part of each groove of the guide member is ended by cylindrical surface with the internal diameter equal to the diameter of the slide block circle, and the width of grooves equal to the remaining part of the slide block circle, while the lower portion of the box side walls is provided with two dead stops.

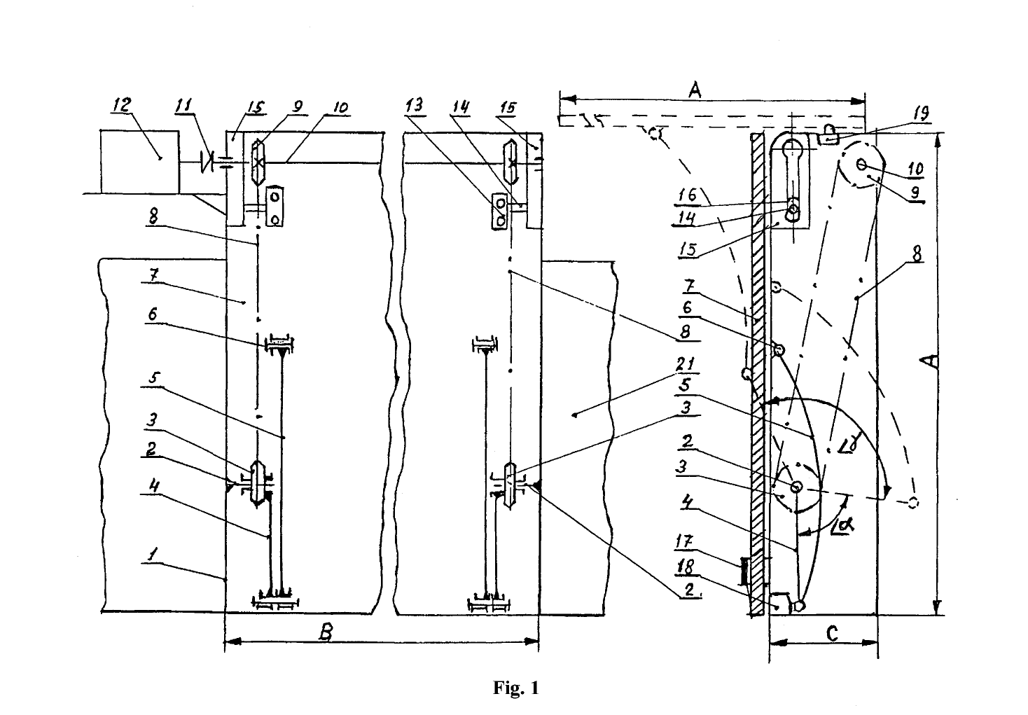

FIG. 1 shows the scheme of mechanical elevating and revolving gates.

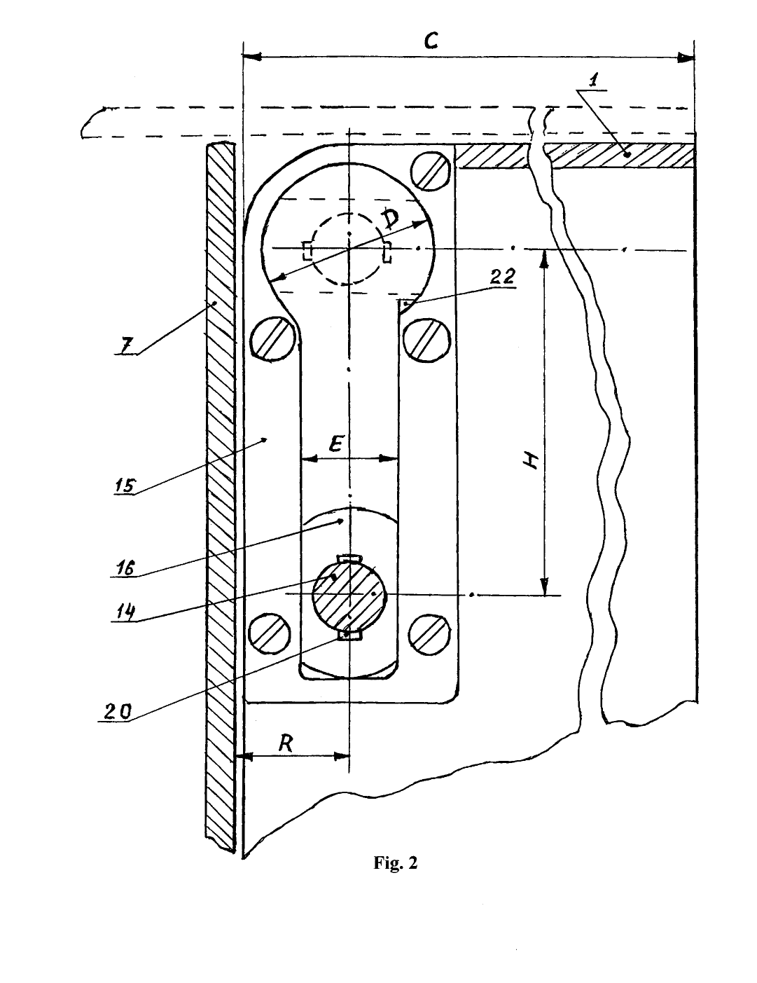

FIG. 2 shows the guide member with a groove, in which the slide block of the monolithic plate is placed.

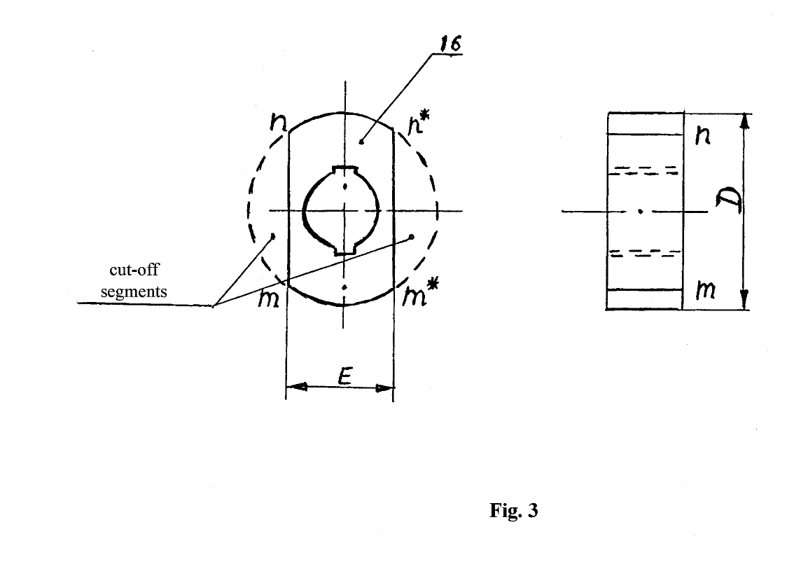

FIG. 3 shows the slide block with designation of its working surfaces.

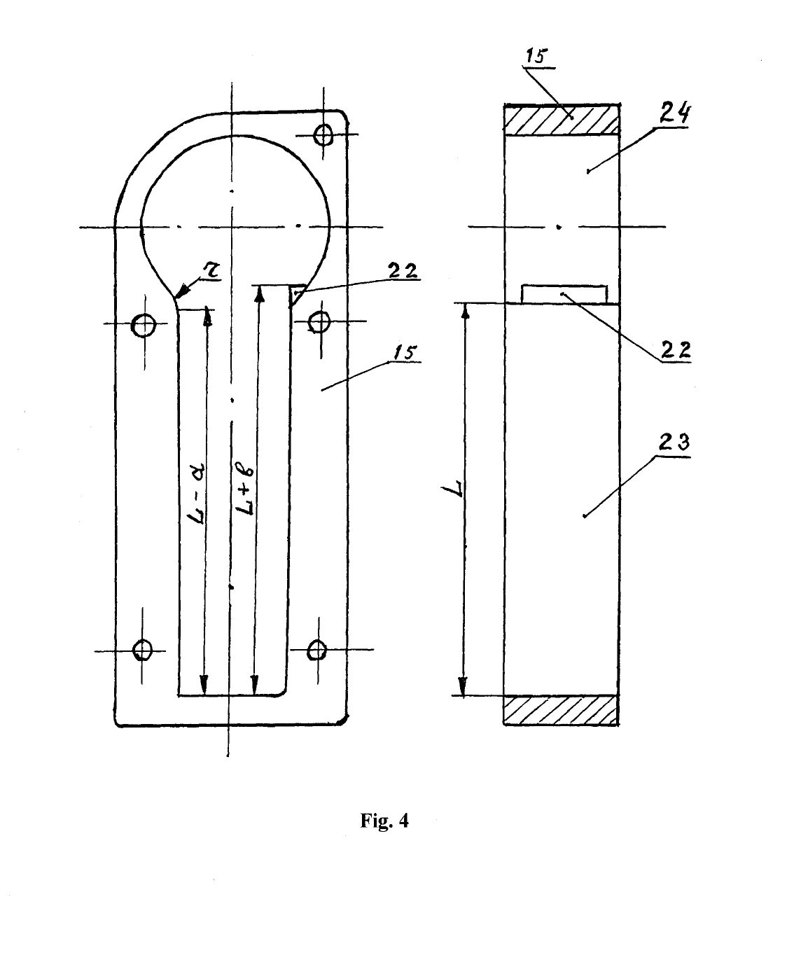

FIG. 4 shows the guide member with a groove and a cylindrical surface.

The mechanical elevating and revolving gates consist of the support box 1 with two half-axles 2 rigidly attached to its side walls (one on the left side wall and the other on the right side wall). The sprocket 3 and the crank 4, being rigidly interconnected, are freely rotated on each half-axle. The crank 4 is pivotally connected to the rod 5 which is attached to the middle part of the monolithic plate 7 with the hinge 6. The sprocket 3 is linked through the chain 8 to the sprocket 9 rigidly fixed on the drive shaft 10. The drive shaft 10 is connected through the clutch 11 to the drive and control system unit 12. Two brackets 13 are rigidly fixed in the upper part of the plate 7 (one is on the right, and the other is on the left). The bracket 13 is provided with the pin 14, whereupon the slide block 16 with the diameter (D) and thickness (F) is secured. The slide block 16 is disposed in the groove of the guide member 15. The lower part of the side walls of the box 1 is provided with two dead stops 17. The crank 4 contacts the end switch 18. Another end switch 19 is located on the upper yoke of the box 1. The slide block 16 is fixed on the pin 14 with keys 20. The box 1 is attached to the fence 21 and to the foundation.

The guide member 15 has a groove. The groove's flat surfaces 23 with length (L) are ended by the cylindrical surface 24 with the diameter (D). To ensure smooth operation of the mechanism, the guide member 15 can be provided with an additional stop 22 which increases the length of one flat surface of the groove, while the other flat surface of the groove can be decreased by mating with the cylindrical surface 24 with the radius (r) (FIG. 4). The radius (r) can range from 2 to 3 mm. Travel limitation of the monolithic plate 7 in the direction (B) is not shown.

The gates operate in the following manner. The drive unit 12 is activated through the control system. Movement is transferred through the clutch 11, the drive shaft 10, two sprockets 9, two chains 8, and two sprockets 3 to two cranks 4 that start rotating counterclockwise (FIG. 1, on the right). The cranks 4 start raising the plate 7 through the rods 5 and hinges 6. The plate 7, which forms part of the crank mechanism at that time, is raised vertically upwards. The upper part of the plate 7 is held through two brackets 13, two pins 14, two slide blocks 16, and two guide members 15. The flat surfaces mn and m*n* act as the working surfaces of each slide block 16 (FIG. 3). They slide within the groove of the guide member 15 over the flat surfaces 23 (FIG. 4). The lower part of the plate 7 slides over two dead stops 17. The translational movement continues until the slide block 16 is stopped against the cylindrical surface 24 of the guide member 15. The plate 7 is raised by the amount (H). In this case, the lower edge of the plate 7 appears from under the stops 17. When the cranks are turned through the angle a, the mechanism takes a transitional position (shown by the dotted line). Continuing rotation, the cranks 4 transform the crank mechanism into a four-link chain mechanism. The plate 7 turns round the axis of the cylindrical surface 24 of the guide member 15. The cylindrical surfaces mm* and nn* become the working surfaces of each slide block 16 (FIG. 3). Now, the slide block 16 operates as a cylindrical hinge. The cranks rotate through the angle γ and turn the plate 7. Once the plate 7 is turned by 90 degrees, it takes the horizontal position and presses the switch 19. The motor of the unit 12 stops. The gates are open. The location of the cranks 4, rods 5, and plate 7 in the open position is shown by the dotted line.

The gates are closed by rotation of the cranks 4 in the opposite direction (clockwise). The mechanism transforms from the four-link chain mechanism into the crank one. The plate 7 moves from the horizontal position to the vertical position, after which it is lowered down. The crank 4 passes through the bottom dead center, presses the switch 18 and turns off the drive unit 12. When this happens, the arcuate rods 5 stretch by 0.1-0.2 mm and press the plate 7 against the box 1.

The height (A) and the width (B) of the gates, as well as the rise height (H) of the monolithic plate, are selected taking into account the operating conditions of the entrance gates. If the gates are designed to close a garage incorporated in a building, the box length (C) should be greater than the plate rise height (H) and the distance (R) from the slide block center to the monolithic plate. Accordingly, the garage length can be decreased by this value. If the garage is a separate building, and the upper part of the box 1 is at the roof level, the monolithic plate 7 is partially laid down on the garage roof. The remaining part of the plate 7 forms a protective cover above the garage entrance. The width (E) of the guide member 15 groove, the diameter (D) of its cylindrical surface 24, and the thickness (F) of the slide block 16 are determined by the mechanism strength calculation.

Thus, the plate 7, which has the width slightly greater than the internal dimension of the box 1, is raised vertically upwards to the height (H) that can be up to 100 centimeters, and then turns by 90 degrees, completely opening the aperture in the support box and forming a protective cover above the gates. In the closed position, the plate is firmly pressed against the box which eliminates the use of locks. No snow accumulations can prevent gates from opening and closing.

1. Mechanical elevating and revolving gates comprising a support box, an overlapping monolithic plate, lever mechanisms, connecting hinges, and a drive, wherein, in order to improve the performance, two lateral sides of the plate are connected, in the lower part of the plate, by hinges with two rods of the drive, and two slide blocks having the shape of a circle with parallel cut-off segments are rigidly fixed on the upper parts of these sides, and two guide members with grooves in each of them accommodating slide blocks of the monolithic plate are secured on the side walls in the upper part of the box; wherein the upper portion of each groove of the guide member is ended by a cylindrical surface with the internal diameter being equal to the diameter of the slide block circle, and the width of the grooves being equal to the remaining part of the slide block circle, while the lower part of the box side walls is provided with two dead stops.

2. Mechanical elevating and revolving gates of claim 1, wherein the cylindrical surface of the guide member mates with the groove flat surface with the radius r reducing the length of the groove flat surface.

3. Mechanical elevating and revolving gates of claim 1, wherein an additional stop increasing the length of the groove flat surface is secured on the cylindrical surface of the guide member.
